(19) United States
(12) Patent Application Publication
(10) Pub. No.: US 2005/0041924 A1
(43) Pub. Date: Feb. 24, 2005

(54) Optical device comprising a mode adapter on an optical component with photonic band gap

(76) Inventors: Noureddine Bouadma, Paris (FR); Sarah Ksas, La Bastidonne (FR)

Correspondence Address: SUGHRUE MION, PLLC, 2100 PENNSYLVANIA AVENUE, N.W., SUITE 800, WASHINGTON, DC, 20037, US

(21) Appl. No.: 10/415,292

(22) PCT Filed: Mar. 4, 2003
(86) PCT No.: PCT/FR03/00686

(30) Foreign Application Priority Data
Mar. 5, 2002 (FR) 02/02771

(51) Int. Cl. G02B 6/26

(52) U.S. Cl. 385/43

(57) ABSTRACT

An optical device comprising a Photonic Forbidden Band (PFB) component composed of a thick material including a distribution of regularly spaced holes, the said photonic forbidden band component being delimited by first and second ends and comprising a wave guide of the total internal reflection (TIR) type, characterised in that the photonic forbidden band component comprises a mode adapter integrated on the first and/or second end of the said photonic component, the mode adapter also consists of a distribution of holes in the photonic forbidden band (PFB) component causing an adiabatic widening of the total internal reflection (TIR) waveguide on the said first and/or second end of the component.

The present invention concerns the field of photonic forbidden band (PFB) optical components normally referred to as photonic crystals. The invention concerns more specifically the coupling of an optical signal between an index-jump waveguide, referred to as classic in the remainder of the description, and a waveguide of a photonic crystal.

The concept of photonic crystal appeared recently and the first component of this type was produced by Eli Yablonovitch in 1991. A PFB component consists of a thick dielectric material, for example an III-V semiconductor, including a distribution of regularly spaced patterns, referred to as “holes”. The holes are generally air but can be composed of another dielectric material, distinct from the thick material, with a refractive index less than that of the thick material. In a three-dimensional PFB component, the patterns or holes generally have the shape of balls, and in a two-dimensional PFB component the patterns generally have the shape of cylinders.

The regular arrangement of the holes in the thick material makes it possible to assimilate such a component to a crystal, known as a photonic crystal. A periodic structure of this type causes the creation of a photonic band framed by forbidden energy bands, in a similar fashion to the electron structure of a semiconductor crystal.

In a PFB component, the position of the photonic band in the frequency band is determined by the spacing between the holes, that is to say the pitch, and the width of this photonic band is fixed by the degree of filling of the holes in the thick material (known as “air filling”), that is to say it depends on the diameter of the said holes. Thus it is possible to produce a PFB optical component which is completely reflective in a given spectral band. For example a pitch of 200 to 300 nm of the holes creates a photonic band in the near infrared.

The PFB components are the subject of many applications and experiments for the transmission, emission or detection of optical signals. They constitute almost perfect filters and make it possible to achieve excellent performance with regard to the propagation of optical signals, in particular for curved waveguides.

It is in fact possible to create a waveguide in a PFB component by creating a defect in the structure of the photonic crystal in order to produce a waveguide with total internal reflection or TIR. Such a defect consists of an absence of crystalline structure, that is to say an absence of holes in a given area of the crystal. For example, such a defect can be introduced by eliminating an entire row of holes over a given depth of the PFB component.

A TIR waveguide has very advantageous optical properties, in particular for the guidance of an optical signal. This is because the photons constituting the optical signal propagate in the defect created by the absence of holes and remain perfectly confined by the material having the forbidden bands. In the case of a two-dimensional PFB component, the forbidden band material confines the optical signal laterally and the waveguide can also be confined vertically by a so-called classic index-jump structure.

Thus, according to the pitch, diameter and depth of the holes in the PFB component, a TIR guide enables an optical signal to be propagated almost without loss in a given frequency band.

Nevertheless a problem is posed when a PFB component of this type must be combined with a so-called classic optical component. In a classic component, the waveguide (a fibre or a planar guide) is characterised by a fading propagation of the optical signal and represented by a difference in refractive index between the material constituting the core and the material constituting the cladding of the guide. For a monomode transmission of an optical signal, the core of a classic waveguide has a diameter (in the case of a fibre) or a width (in the case of a planar guide) of approximately 1 to 5 μm. On the other hand, in a monomode TIR waveguide, the spread of the mode may be very much less. This is because it is possible, for a TIR guide, created by an absence of holes, to achieve a width of only 300 to 500 nm.

Such a difference in mode size, by a factor of approximately 10, necessarily gives rise to a significant problem of optical coupling between the classic waveguide and the total internal reflection waveguide. Thus the PFB components have interesting properties when they are used alone or together but lose their advantages when they have to be combined with so-called classic components.

This is because the losses introduced during the coupling of an index-jump waveguide with a TIR waveguide may reach 70%, which cancels out the advantageous properties mentioned above with reference to TIR waveguides.

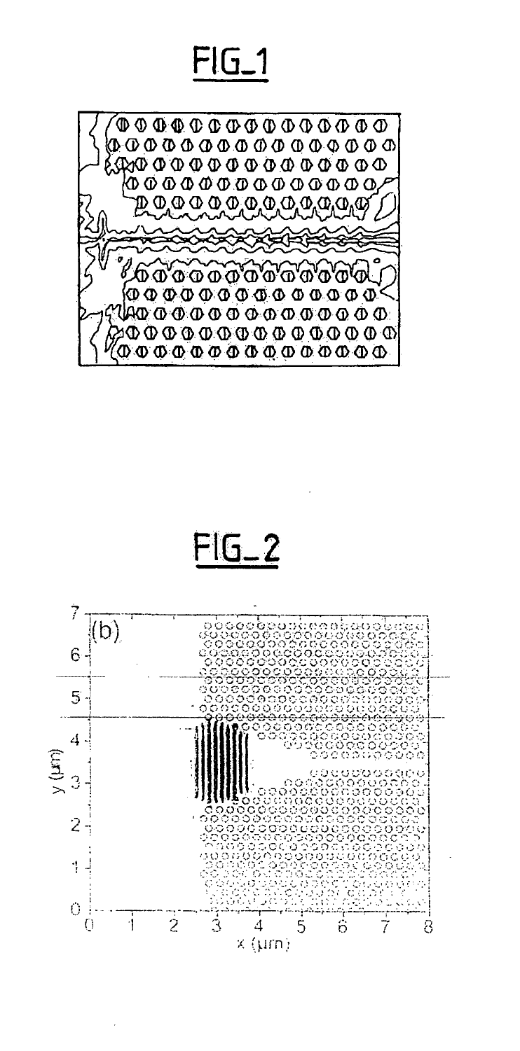

FIG. 1 for this purpose illustrates a simulation of the coupling of an optical signal at 1.55 μm between an index-jump waveguide with a TIR waveguide. The holes in the crystalline structure of the photonic component have a constant pitch of 0.45 μm and a constant diameter of 0.15 μm. The simulated coefficient of transmission is only 30%.

The problems of optical coupling between so-called classic components are well-known in the field of optical transmissions, specifically in the case of monomode signal transmissions.

The coupling problems are essentially due to the fact that the mode sizes of the optical signal are different from one component to another. To resolve this problem, it is known how to use mode adapters which consist in modifying the size of the mode of an optical signal propagating in a component before coupling it in another component. One of the solutions adopted for optical components with index-jump guidance is the creation of a cone (referred to as a taper). The taper constitutes an adiabatic variation in the width or diameter of the guide core. An adiabatic variation of this type allows modification without loss of the size of the mode of a monomode signal to be coupled.

Nevertheless, the coupling problems known and dealt with up to the present time concerned waveguides of the same type (with index-jump guidance) with limited mode size differences.

In the case of coupling between an index-jump waveguide with a TIR waveguide, the difference in mode size may attain a factor of ten, as mentioned previously. However, it is not possible to reduce the size of the core of an index-jump waveguide adiabatically and by such a factor without considerably elongating the size of the optical component, for reasons of current technological limits.

One solution to the problem of coupling between an index-jump waveguide and a TIR waveguide is described in the Japanese patent application JP 2001/004869 and consists in broadening the TIR guide by removing several rows of holes in the photonic crystal. Nevertheless this solution has a serious drawback if it is wished to maintain a monomode propagation of the optical signal in the TIR guide.

Another known solution is described in the publication “Photonic crystal tapers for ultracompact mode conversion” by Thomas D. Happ et al; Optics Letters, Vol. 26, No. 14 of 15 Jul. 2001. The solution proposed in this publication is illustrated in FIG. 2 and consists in effecting an adiabatic broadening of the waveguide (TIR) on the coupling end of the photonic component. In this way a taper is produced in the TIR guide of the photonic component. This solution considerably improves the transmission coefficient. This solution does however have a certain complexity with regard to control of the arrangement of the holes in the photonic component in order to produce a truly adiabatic taper.

Thus the object of the present invention is to propose an optical device comprising a mode adapter which makes it possible to achieve an improved coefficient of coupling between the index-jump waveguide of a so-called classic component and a total internal reflection waveguide of a photonic forbidden band component.

To this end, the invention proposes to integrate the mode adapter in the photonic forbidden band component.

Another aim of the invention is to propose an adapter whose implementation is simplified.

More particularly, the present invention relates to an optical device comprising a Photonic Forbidden Band (PFB) component composed of a thick material including a distribution of regularly spaced holes, the said photonic forbidden band component being delimited by first and second ends and comprising a waveguide of the Total Internal Reflection (TIR) type, characterised in that the photonic forbidden band component comprises a mode adapter integrated on the first and/or second end of the said photonic component, the said adapter consisting of a reduction in the diameter of the holes from the said end in the direction of the waveguide (TIR).

The arrangement of the holes thus remains constant compared with the known solution illustrated in FIG. 2. As indicated previously, the degree of filling (the “air filling”) has an influence on the width of the photonic band and therefore directly on the coefficient of transmission of the TIR waveguide. By reducing the diameter of the holes progressively, it is thus possible to adapt the coefficient of transmission and to produce a mode adapter with minimised optical losses.

According to one embodiment, the mode adapter can combine the advantages of a reduction in the holes according to the invention and the production of a taper according to the known solution presented above. Thus the adapter would also consist of a distribution of the holes in the photonic forbidden band (PFB) component giving rise to an adiabatic widening of the waveguide (TIR) on the said first and/or second end.

The invention also concerns an optical system comprising an optical component comprising an index-jump optical waveguide coupled with a photonic forbidden band optical component comprising a waveguide of the total internal reflection (TIR) type, characterised in that the coupling between the said waveguides is provided by an optical device comprising a Photonic Forbidden Band (PFB) component composed of a thick material including a distribution of regularly spaced holes, the said photonic forbidden band component being delimited by first and second ends and comprising a waveguide of the Total Internal Reflection (TIR) type, the photonic forbidden band (PFB) component also comprising a mode adapter integrated on the first and/or second end of the said photonic component, the said adapter consisting of a reduction in the diameter of the holes from the said end in the direction of the waveguide (TIR).

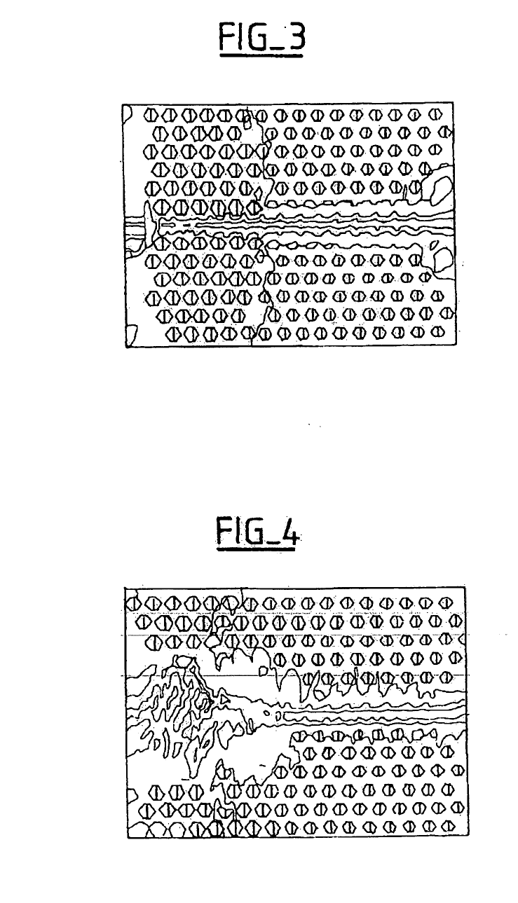

The particularities and advantages of the present invention will emerge more clearly from a reading of the following description, given by way of illustrative example and non-limitingly, and made with reference to the accompanying drawings, in which:
FIG. 1, already described, illustrates a simulation of coupling in a photonic component comprising a TIR waveguide;
FIG. 2, already described, is a diagram of a mode adapter for a photonic component according to the prior art;
FIG. 3 illustrates a simulation of coupling in a photonic component comprising an adapter according to a first embodiment of the invention;
FIG. 4 illustrates a simulation of coupling in a photonic component comprising an adapter according to a second embodiment of the invention.

The invention proposes to produce a mode adapting optical device for effecting improved coupling between a classic index-jump optical waveguide and a waveguide of the total internal reflection (TIR) type. The TIR waveguide is created in a photonic forbidden band (PFB) component, as described previously, which is delimited by first and second ends.

The distribution of the holes in the photonic component can be a matrix of lines with a regular mesh of holes in the thick material, but can also consist of a more complex mesh.

The pitch of the distribution of holes in the photonic component is preferably constant so as to keep the position of the forbidden band on a fixed frequency range.

According to the invention, the mode adapter is integrated in the photonic forbidden band component, either on the first end for optical coupling at the entry to the TIR guide, or at the second end for optical coupling at the exit from the TIR guide. The device according to the invention is intended to be integrated in a more complex optical system including an entry optical guide and/or an exit optical guide and at least one photonic forbidden band component able to process, transmit, detect or emit an optical signal. The device according to the invention is therefore intended to afford improved coupling between the entry/exit guides of conventional design with index jump and a photonic forbidden band component in an optical system.

According to the invention, the optical device comprises a photonic component where the diameter of the holes decreases from the first end to the second end of the component. It is possible to envisage the same design with a decrease in diameter of the holes from the second end to the first end. The decrease in the diameter of the holes is not necessarily maintained from one end to the other. The diameter of the holes can become constant again after a distance making it possible to effect the adiabatic adaptation of the optical signal propagation mode. Thus it can be envisaged having a decrease in the diameter of the holes from the first end of the component to the second for coupling at the entry, followed by a series of holes of constant diameter and an increase in the said diameter as far as the second end for exit coupling.

The simulation in FIG. 3 illustrates for this purpose the coupling of an optical signal at 1.55 μm between an index-jump waveguide with a TIR waveguide comprising an adapter according to the invention. The holes in the crystalline structure of the photonic component have a constant pitch of 0.45 μm but the diameter decreases from the first end (to the left) towards the second end (to the right), changing from 0.19 μm to 0.18 μm and to 0.16 μm, and then remains constant at 0.15 μm as far as the second end. The simulated coefficient of transmission is then 50%.

According to another embodiment of the invention, it is particularly advantageous to combine the effects of the invention with a taper, that is to say to produce an optical device comprising a photonic component where the diameter of the holes varies from one end of the photonic component to the other and where the distribution of the holes is such that a taper is formed in the TIR guide at one or other of the ends of the photonic component.

The simulation in FIG. 4 illustrates the coupling of an optical signal at 1.55 μm between an index-jump waveguide with a TIR waveguide comprising such an adapter. The holes in the crystalline structure of the photonic component have a constant pitch of 0.45 μm but the diameter decreases from the first end (to the left) towards the second end (to the right) and the taper extends over approximately seven columns of holes. The simulated coefficient of transmission is then 90%.

According to the application, these various embodiments described can be combined on the same component in order to produce a mode adapter at the entry and/or exit of a component of the photonic crystal type.

The invention thus finds an advantageous application in optical systems comprising classic optical waveguides of the index jump, planar or fibre type, to be coupled with photonic forbidden band components by means of an optical device according to the present invention.

1. An optical device comprising a Photonic Forbidden Band (PFB) component composed of a thick material including a distribution of regularly spaced holes, the said photonic forbidden band component being delimited by first and second ends and comprising a waveguide of the Total Internal Reflection (TIR) type, characterised in that the photonic forbidden band component comprises a mode adapter integrated on the first and/or second end of the said photonic component, the said adapter consisting of a reduction in the diameter of the holes from the said end in the direction of the waveguide (TIR).

2. An optical device according to claim 1, characterised in that the mode adapter is also formed by a distribution of the holes of the photonic forbidden band (PFB) component giving rise to an adiabatic widening of the total internal reflection (TIR) waveguide on the said first and/or second end of the component.

3. An optical device according to claim 1, characterised in that the distribution of the holes in the photonic forbidden band component is a matrix of lines.

4. An optical device according to claim 1, characterised in that the pitch of the distribution of the holes in the photonic forbidden band component is constant.

5. An optical system comprising an optical component comprising an index-jump optical waveguide coupled with a photonic forbidden band optical component comprising a waveguide of the total internal reflection (TIR) type, characterised in that the coupling between the said waveguides is provided by an optical device comprising a Photonic Forbidden Band (PFB) component composed of a thick material including a distribution of regularly spaced holes, the said photonic forbidden band component being delimited by first and second ends and comprising a waveguide of the Total Internal Reflection (TIR) type, the photonic forbidden band (PFB) component also comprising a mode adapter integrated on the first and/or second end of the said photonic component, the said adapter consisting of a reduction in the diameter of the holes from the said end in the direction of the waveguide (TIR).

6. A system according to claim 5, characterised in that the mode adapter is also formed by a distribution of holes in the photonic forbidden band (PFB) component giving rise to an adiabatic widening of the total internal reflection (TIR) waveguide on the said first and/or second end of the component.
